(19) United States
(12) Patent Application Publication
(10) Pub. No.: US 2007/0173961 A1
(43) Pub. Date: Jul. 26, 2007

(54) AUTOMATION CONTROLLER WITH INTEGRATED HMI AND MODULAR I/O

(76) Inventor: Shalabh Kumar, Kildeer, IL (US)

Correspondence Address: AUTOTECH TECHNOLOGIES, LLP, 4140 UTICA RIDGE ROAD, BETTENDORF, IA, 52722, US

(21) Appl. No.: 11/625,812

(22) Filed: Jan. 22, 2007

Related U.S. Application Data
(60) Provisional application No. 60/766,480, filed on Jan. 22, 2006.

(51) Int. Cl. G05B 15/00

(52) U.S. Cl. 700/83

(57) ABSTRACT

Automation Controller with integrated HMI and Modular I/O is described. The controller offers advantage of being a single physical unit over traditional controllers, while offering the flexibility of modular I/O.

### CROSS REFERENCE TO RELATED APPLICATIONS

This application is entitled to the benefit of Provisional Patent Application Ser. No. 60/766480 submitted on Jan. 22, 2006.

### FEDERALLY SPONSORED RESEARCH

Not applicable.

### SEQUENCE LISTING OR PROGRAM

Not applicable

### FIELD OF INVENTION

This invention pertains to the field of industrial automation and control.

### BACKGROUND OF INVENTION

Automation controllers are used to control and automate machines, manufacturing plants and processes. FIG. 1 shows a traditional automation controller system. A typical system consists of an HMI (Human Machine Interface) 10 and a controller 11. The two are connected using a cable 12. The HMI 10 can be a graphical display with touch panel, an alphanumeric display with key pads, or a set of push buttons, switches, indicators etc. The automation controller 11 consists of a controller 13 and one or more I/O modules 15. The controller communicates with the I/O modules over a bus 14. The I/O typically is modular that is it can be added or removed in the field. Filed devices 16 are connected to I/O modules 15.

FIG. 2 shows another automation control system. Here HMI 20, Controller 22 and I/O 23, are all integrated in one physical unit. The HMI 20 and controller 22 communicate with each other over internal bus or communication link 21. The I/O in this design is factory-ordered and is not field-replaceable. I/O 23 is wired to field devices 24.

This invention describes automation controller with integrated HMI and modular I/O providing flexibility to users in I/O selection and in field replacement of I/O modules.

### BRIEF DESCRIPTION OF DRAWINGS

FIG. 1 shows a block diagram of a traditional modular automation control system.

FIG. 2 shows block diagram of currently available integrated controllers.

FIG. 3 shows a block diagram of automation controller of this invention.

FIG. 4A and 4B shows an example of this invention, i.e. an automation controller with integrated HMI and Modular I/O. The HMI in this example is a graphical touch panel.

FIG. 5 shows another example of this invention. The HMI in this example consist of a text based display and key pad.

FIG. 6 shows a block diagram of communication between PC, PLC or controller and HMI.

FIG. 7A and 7B shows logic of switching communication lines between PC, PLC and HMI.

### DESCRIPTION OF INVENTION

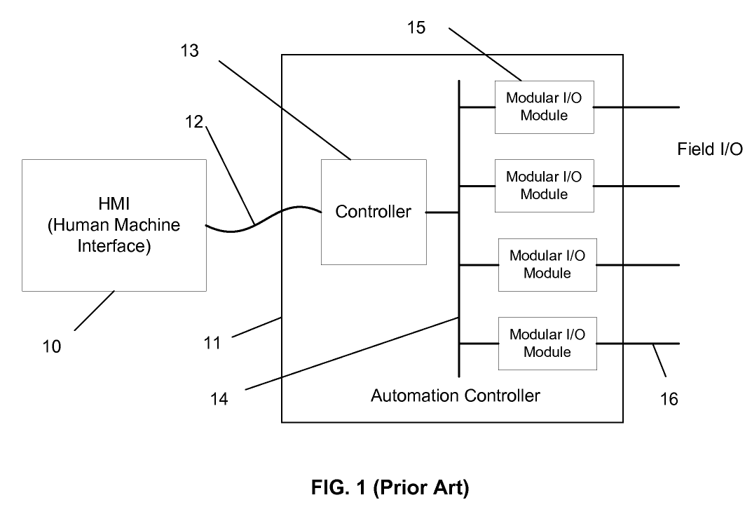

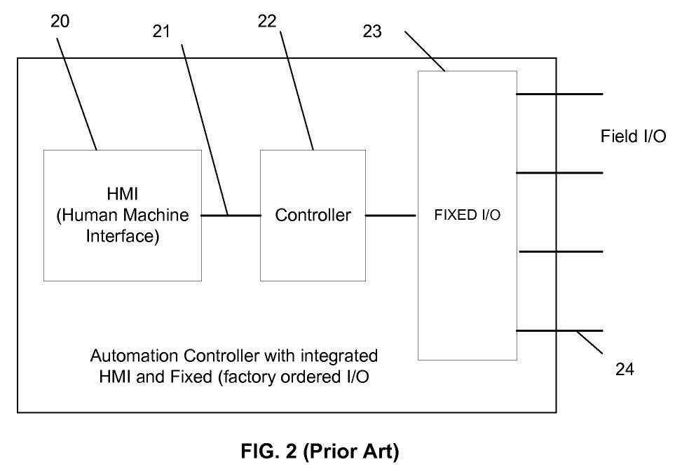

FIG. 1 shows a system block diagram of an automation controller where controller and HMI are separate physical units, and communicate with each other over some type of communication protocol. FIG. 2 shows block diagram of integrated automation controllers that have fixed input/ouput.

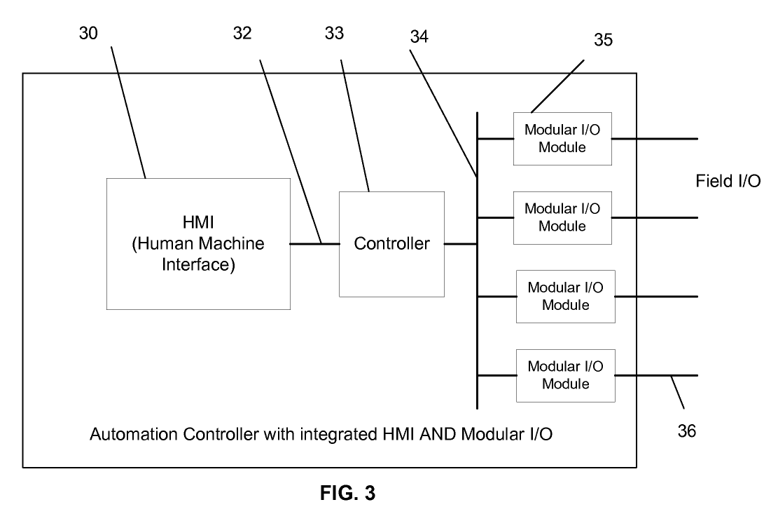

FIG. 3 shows a block diagram of automation controller of this invention. The invention integrates HMI 30, controller 33 and modular I/O 35 in one unit. This approach has the advantage of being a single physical unit over the traditional automation controller system of FIG. 1. Compared to the automation controller of FIG. 2, the new controller of FIG. 3 offers users flexibility of modular I/O.

The HMI 30 in FIG. 3 can be any human machine interface, such as a touch panel with graphical display, a text based display with key pad, discrete buttons, switches, indicator lamps, meters etc. The HMI 30 will communicate with controller 33 over appropriate interface 32.

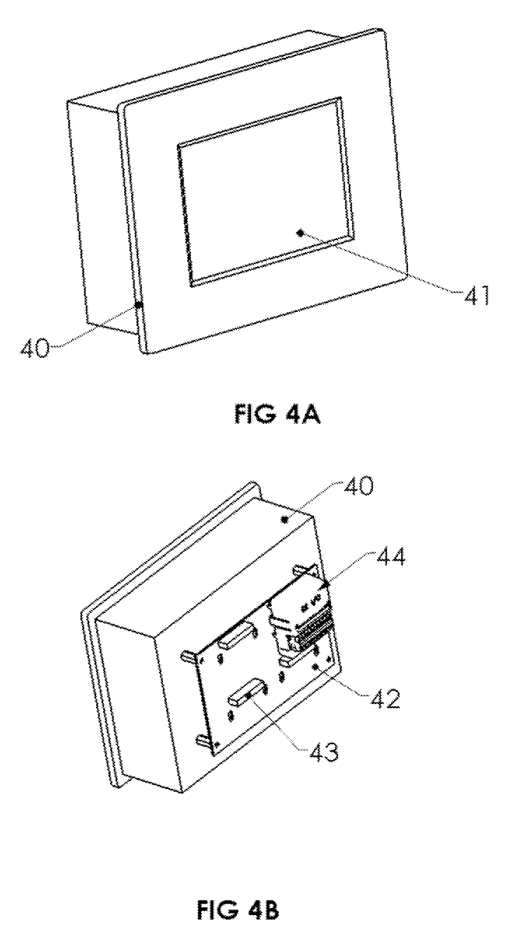

An implementation of the automation controller of FIG. 3 is shown in FIG. 4A and FIG. 4B. FIG. 4A shows automation controller's front view. In this embodiment, the HMI 40 is a graphical display with a touch screen 41. FIG. 4B shows rear view of the automation controller. It shows controller board 42, with connectors 43 for plug-in I/O modules 44. In this embodiment the HMI and controller have their own microprocessors and the two communicates with each other over a serial connection internal to the unit. The two microprocessors can also communicate using a dual ported RAM. The invention describes two independent processors; however the same concept will work if the HMI and the controller in the unit share processor. Having two independent processors improves performance of the system.

In this embodiment the HMI section and the controller section both have independent power supplies. Thus if the HMI malfunctions, the controller section continue to work.

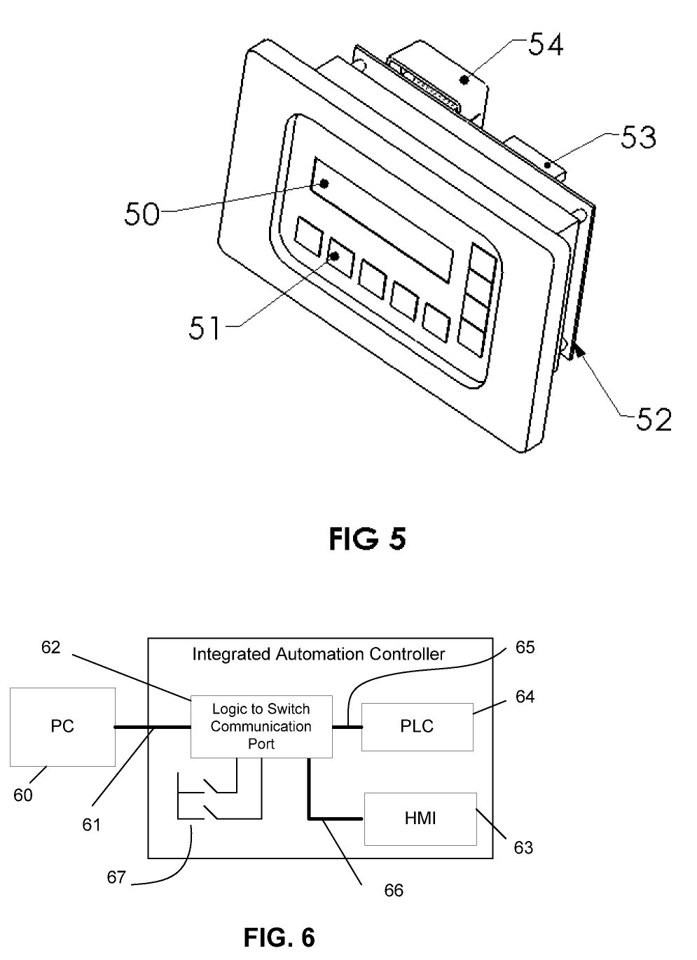

Another implementation of the invention is shown in FIG. 5. The HMI in this example consists of a text-based display 50, plurality of keys 51. The controller 52 is on the backside of the unit. Modular I/O 54 is field installable in connectors 53 provided on board 52.

FIG. 6 shows automation controller from communication perspective. A PC 60 is used to program the controller or the PLC 64 as well as HMI 63. During programming PC 60 connects to PLC 64 or HMI 63 depending up on what is being programmed. During operation or run mode, the HMI 63 and PLC 64 needs to communicate with each other. To make the product cost effective, the PLC 64 has only one communication port. Inexpensive DIP switches 67 and simple logic 62 switches communication lines between the three (PC, PLC and HMI). Switches 67 will connect PC communication port 61 to PLC port 65 or HMI port 66, or PLC port 65 to HMI port 66.

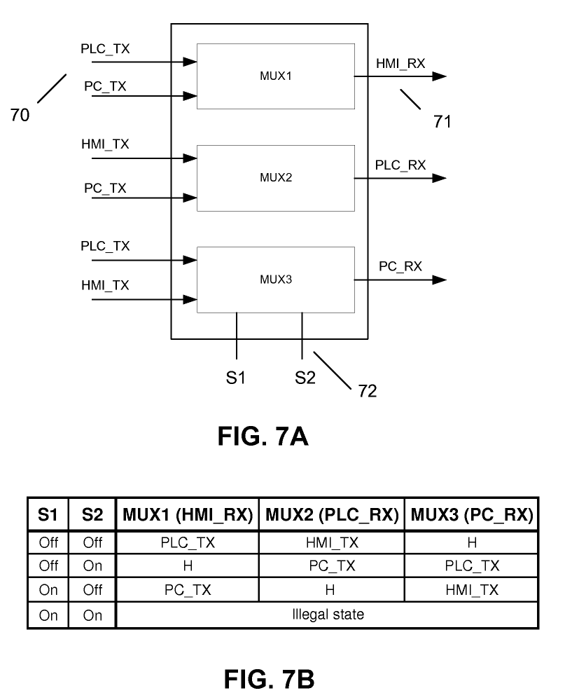

FIG. 7A and 7B explains the switch logic 62. In the FIG. 7A, the PLC_TX, PC_TX and HMI_TX are the transmit line from PLC, PC and HMI respectively, while HMI_RX, PLC_RX and PC_RX are the receive lines from HMI, PLC and PC respectively. Switch S1 and S2 72 control how various _TX lines are routed to _RX lines through multiplexers. Table in FIG. 7B shows the state of switches and corresponding state of multiplexers. For example when S1 and S2 both are off, the MUX1 connects PLC_TX to HMI_RX, and MUX2 routes HMI_TX to PLC_RX, effectively connecting PLC and HMI. The PC in this state will not communicate with HMI or PLC.

The graphical operator interface has its own microprocessor and have state of the art features. User designs screens for the operator interface using a PC based program by selecting and placing various objects such as push buttons, meters, numeric displays, recipe, line graph etc. These screens may also be edited directly in the operator interface, effectively editing on-line. This means user can modify the screens designs while operator interface is still communicating with the controller section. The user program can be backed up in a removable flash card. The visibility of objects on operator interface screen may be controlled. Recipe object allows users to preset several parameters with push of one button. The operator interface allows you to fine tune these recipe objects right from the panel. The operator interface have communication ports where a variety of peripheral devices can be used. These include serial printers, barcode readers, and marquees. The design of operator interface unit is such that a single printed circuit board can support different sizes of displays.

The controller supports modular I/O. A variety of I/O modules are available. These include analog output, analog input, DC input, DC output, AC input, AC output, Relay output, High speed counter modules, and modules that offer input and output on single module.

The Controller support a run and edit mode. Surface mount LED indicate these modes. Surface mount DIP switches are used to select the modes.

The controller and module printed circuit boards are parallel to each other. The modules have surface mount LED indicators placed to the field device connector. The field device connector is a removable terminal block.

The controller supports a variety of industrial communication networks. These include DeviceNet, ProfiBus, and Ethernet.

What is claimed is:

1. An integrated automation controller comprising of programmable operator interface means, logic control means, and input and output means, wherein these said means are all housed in a single control unit and said input and output means comprise of flexible and plug-in input and output modules for controlling field devices.

2. An integrated automation controller of claim 1 wherein said operator interface means and logic control means both have separate microprocessors.

3. An integrated automation controller of claim 1 wherein said operator interface means and logic control means both have separate power supplies.

4. An integrated automation controller of claim 1 wherein operator interface means include a graphical touch panel.

5. An integrated automation controller of claim 1 wherein operator interface means include a multi line text display and a key pad.

6. An integrated automation controller of claim 1 wherein operator interface means includes means to perform on-line edit of user program.

7. An integrated automation controller of claim 1 wherein user program for said operator interface means can be stored in a compact flash module.

8. An integrated automation controller of claim 1 wherein operator interface means include means to control the visibility of operator interface objects on its touchscreen.

9. An integrated automation controller of claim 1 wherein operator interface means includes means to fine-tune a program recipe for said controller.

10. An integrated automation controller of claim 1 wherein operator interface means includes means to communicate to an external barcode reader.

11. An integrated automation controller of claim 1 wherein operator interface means includes means to communicate to an external marquee.

12. An integrated automation controller of claim 1 wherein operator interface means includes a common printed circuit board assembly common to a variety of different size displays in said operator interface.

13. An integrated automation controller of claim 1 wherein logic control means include means to control analog output modules.

14. An integrated automation controller of claim 1 wherein logic control means include means to control a variety of mixed input and outputs on the same module

15. An integrated automation controller of claim 1 wherein logic control means include means to show operating modes of said controller with light emitting diodes.

16. An integrated automation controller of claim 15 wherein said light emitting diodes are surface mounted to the printed circuit board in the logic control means.

17. An integrated automation controller of claim 1 wherein logic control means include a motherboard parallel to the printed circuit boards in the input and output modules.

18. An integrated automation controller of claim 1 wherein said input and output modules have indicator means to show the status of inputs and outputs connected to said controller.

19. An integrated automation controller of claim 18 wherein said indicator means comprise of surface mount light emitting diodes.

20. An integrated automation controller of claim 18 wherein said input and output modules include means to quickly disconnect field wiring from said modules.

21. An integrated automation controller of claim 20 wherein quick disconnect means consist of a removable terminal block.

22. An integrated automation controller of claim 1 having means to communicate to common industrial networks.

23. An integrated automation controller of claim 22 wherein said communications means include means to communicate over Ethernet.

24. An integrated automation controller of claim 22 wherein said communication means includes means to communicate to Devicenet or Profibus.

25. An integrated automation controller of claim 1 wherein logic control means includes means to control an auto-tuned PID loop.

26. Antegrated automation controller of claim 1 wherein input and output modules have means to count pulses from an external encoder at a high frequency and turn on and off outputs conditional upon pulse count.
